(19) United States
(12) Patent Application Publication
(10) Pub. No.: US 2007/0126605 A1
(43) Pub. Date: Jun. 7, 2007

(54) Method for updating a digital map

(75) Inventors: Mario Aleksic, Trossingen (DE); Alexander Bracht, Esslingen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/568,222

(22) PCT Filed: Aug. 10, 2004
(86) PCT No.: PCT/EP04/08924

§ 371 Date: Nov. 16, 2006

(30) Foreign Application Priority Data
Aug. 16, 2003 (DE) 103 37 621.6

(51) Int. Cl. G08G 1/123

(52) U.S. Cl. 340/995.14

(57) ABSTRACT

A method of updating a digital map comprising elements of a traffic route network, in a user end device on which at least one user application of the digital map runs, using a second digital map which is arranged in a control center, in which only a subset of elements of the digital map required for a current user application is updated in close to real time conditions when the elements of the digital map are required by a current user application. Since the user end device can precisely delimit the element subset required for a current user application, only minimum data transmission is required.

The invention relates to the updating of elements of a digital map of a traffic route network in a user end device, for example a vehicle navigation device or a telematics control center for map based telematics services. Such updates can be performed using a centrally arranged, second digital map which is always kept up to date for example by the manufacturer of the digital map. As a result of the updating, elements of the second digital map which are not included in the digital map of the user end device in the present form since the elements have, for example, been newly added to the second digital map or have in the meantime been changed or deleted in the second digital map, are supplied to the digital map of the user end device.

A digital map (for example in the form of a CD-ROM, DVD-ROM or a file which is stored in a read/write memory) in a device which is arranged at a user's premises permits access to the geo-based information of the digital map by a user application (for example a vehicle routing system) which is running on this device. Examples of such devices are a portable navigation unit, a navigation device which is permanently arranged in a vehicle, a “geo-data sensor”, i.e. a vehicle-mounted control device which has access to a digital map, or a telematic control center which itself provides an end user with map based telematic services, for example “off-board” navigation (telematic center based vehicle navigation). When such devices are used, the problem arises that data which is stored in the digital map and which represents elements of a traffic route network “becomes outdated”, for example if new roads are built or detours are set up or if POIs (“points of interest”) change their position or opening times. Since modern user end devices have digital maps which cover entire countries or even continents, the updating of these digital maps to the respective most up to date state requires either comprehensive transmission of data to the user end device or requires the digital map to be replaced entirely (for example by replacing the DVD-ROM being used). Particularly in the case of mobile user end devices which are supplied with data via an air interface, this entails high costs and/or the transmission of data takes a long time.

Reference is made to U.S. Pat. No. 6,317,753 B1 as prior art which forms the generic type.

The problem that arises of supplying a digital map which is always up to date—and which ensures that the user applications running on the device for the user function without problems—at the user end device with minimum expenditure in terms of data transmission.

The object is achieved by means of the features of the independent patent claims 1 and 2. The subclaims relate to advantageous embodiments and developments of the invention.

According to the invention, an element subset—to be updated—of the digital map can be selected at the user end device and updating of this element subset can be requested from the control center via an at least temporary data link, wherein, after such a request has been received, the control center automatically selects, in addition to the element subset to be updated, an additional element subset in the second digital map in such a way that the digital map is internally consistent after the updating, and wherein data for updating the element subset to be updated and data relating to the additional element subset is transmitted from the control center to the user end device via the at least temporary data link and supplied to the digital map. Alternatively, in a first step, after a request from the user end device, the control center transmits data for updating the element subset to be updated to the user end device via the at least temporary data link and supplies it to the digital map, after which, in a second step, the user end device checks whether additional element subsets of the digital map are affected by the updating and as a function of the result of the check the control center automatically requests updating of these additional element subsets in such a way that after the data of the additional subsets has been received and supplied the digital map is internally consistent.

In other words, only a subset of elements of the digital map which is required for a current user application is updated. Since this takes place close to real time conditions at the time at which the corresponding elements of the digital map are required by a current user application, the most up to date state of the digital map is always made available to the current user application. Since the user end device can precisely delimit the element subset of the digital map which is required for a current user application, only a minimum required data quantity, i.e. a minimum expenditure of data transmission, is always implemented. Since at least one additional element subset of the digital map is automatically selected in such a way that after the data of the additional element subset has been received and supplied the digital map is internally consistent, and therefore also has with respect to the user application or each user application running on the user end device, a current digital map is always made available on the user end device, which ensures that the user applications or each user application running on the device functions without problems. In other words by means of an appropriate completion with an additional element subset it is ensured that the update for the digital map contains internally consistent data with respect to the current application on the user end device.

The element subset to be updated preferably comprises a specific geographic area, for example a route planned by the user, together with a corridor surrounding the route, a specific road class, for example freeways, POI (“points of interest”, i.e. locations which are of interest to a user such as, for example, gas stations or restaurants) and/or classes of POI.

The consistency with respect to the user application which is running or with respect to any user application which is running on the user end device is particularly advantageously ensured by virtue of the fact that the additional element subset is selected automatically in such a way that after the data for updating the at least one additional element subset has been supplied there is no route in the digital map of the user end device at whose end it is inevitably necessary for traffic route network users to turn around (i.e. a dead end) if this route is not also included in the second digital map (i.e. is also embodied as a dead end) and/or there are no two routes at whose ends traffic route network users must inevitably turn around if these two routes are connected in the second digital map by a small number of edges (i.e. these few edges are included as elements of the second digital map), and/or there are no routes on which allocated turning around restrictions apply which are included in the second digital map as a result of routes (for example if it is forbidden to turn off from edge A to edge B, both the elements “edge A” and the “edge B” are to be updated since otherwise if an adjoining subset is updated later the element “edge B” would be added but not the prohibition on turning off since this is included in the already updated subset), and/or route data which is relevant to reaching a POI (if, for example, a new POI is added as an element to the digital map, a route which leads to the POI and is newly created is automatically selected for updating even if only POI updating was requested) is as up to date as the data of the POI itself, and/or element dependencies are transmitted completely (i.e. if an element transaction is dependent on a preceding element transaction).

A way of using the invention which provides virtually total area coverage can then be implemented particularly easily if the at least temporary data link between the user end device and the control center is embodied as a mobile radio link since nowadays mobile phone networks are available with virtually total area coverage. Alternatively or additionally it is also possible to use short range communication (for example “Bluetooth”). In specific cases, for example, in the case of a portable navigation unit which is inserted into a fixed rechargeable battery and synchronization unit (“cradle”) or in the case of a telematic control center it is also possible to provide a fixed network connection (for example ISDN).

The user end device preferably automatically requests that the control center perform updating when a user application of the digital map is started and/or periodically. This ensures that a digital map in the user end device is always up to date. Alternatively or additionally corresponding information is provided to the user end device by the control center.

It is advantageously proposed that corrections of element inaccuracies in the second digital map (for example a change in the route geometry of an already existing route owing to renewed, more accurate measurement) are characterized specifically, wherein, together with the additional element subset, further data items which can be used to restore a logic link between elements in which inaccuracies are corrected by updating and non-corrected elements are transmitted from the control center to the user end device via the at least temporary data link. Alternatively, if the corrections of element inaccuracies are not characterized specifically, it is possible to determine by means of a comparison—in the user end device—between new and old properties of an element whether inaccuracies are corrected, for example by inferring corrections of element inaccuracies when the topology stays the same (i.e. logic links to other elements) and the geometry changes only slightly. If appropriate, it is then possible to set up a logic link to corresponding, uncorrected elements in the user end device.

The data for updating the element subset to be updated preferably also includes such elements of the second digital map which are contained only partially in the element subset to be updated. This permits simplified selection of possible additional element subsets by “protruding” elements. In one advantageous development there is provision for dependencies between elements of the second digital map to be stored at the control center, the additional element subset also including elements of the second digital map on which the elements which are contained only partially in the element subset to be updated are dependent and whose data is more up to date than the data of the elements of the digital map in the user end device.

It is particularly advantageous if information about partitions, that is to say a specific geographic a real breakdown of the digital map in the user end device can be stored at the control center end and a geographic area which is to be updated can be identified by means of a corresponding partition reference. To do this, for example in the case of complex polygonal area boundaries, the entire polygon does not need to be also transmitted to the control center in the updating request of the user end device.

The digital map is updated particularly easily if the user end device is registered at the control center and identifies itself whenever there is a request to the control center. In this case, an update (“version”), for example for a respective geographic area, which has already been respectively transmitted from the control center to the user end device can be stored by the control center.

Simple determination of the additional element subset is made possible by virtue of the fact that when there is a request to the control center the user end device transmits version information of an element subset of the digital map, for example in an edge region of the element subset to be updated.

It is particularly advantageous if an upper limiting value is provided for the size of the additional element subset or of each additional element subset. As a result, the data quantity, usually involving cost, which has to be transmitted from the control center to the user end device is restricted and instead inconsistency in the digital map in the user end device is tolerated. Alternatively or additionally it is also possible to provide an upper limiting value for a total element subset to be transmitted per update.

It is advantageously proposed that logically associated updates of the elements of the digital map are transmitted in combination, for example in the event that an update of an individual element could be made without inconsistency being produced in the digital map. For example, when a freeway exit is moved 500 m by cancelling the old exit the consistency in the digital map is produced in exactly the same way as by the insertion of the new exit. However, if these two updates of individual elements are not transmitted in combination it may be that on updating of the elements either only a part of the freeway, only the old exit, is deleted, and there is thus no exit at all provided any more in the digital map, or only the new exit is inserted, and two exits therefore appear on the digital map.

Preferably, if the digital map in the user end device only has a part of the second digital map arranged in the control center, inconsistency of the digital map is permissible at points at which there is a boundary between a part which is included in the digital map and a part which is not included in the user end device. In particular when geographic areas are newly recorded it is ensured that the entire, additionally recorded geographic region—by means of which the second digital map at the control center end is updated—does not need to be supplied as an update of the digital map.

Various embodiments of the invention will be explained in more detail taking the prior art together with the problems which occur as the starting point and with reference to a drawing, in which:

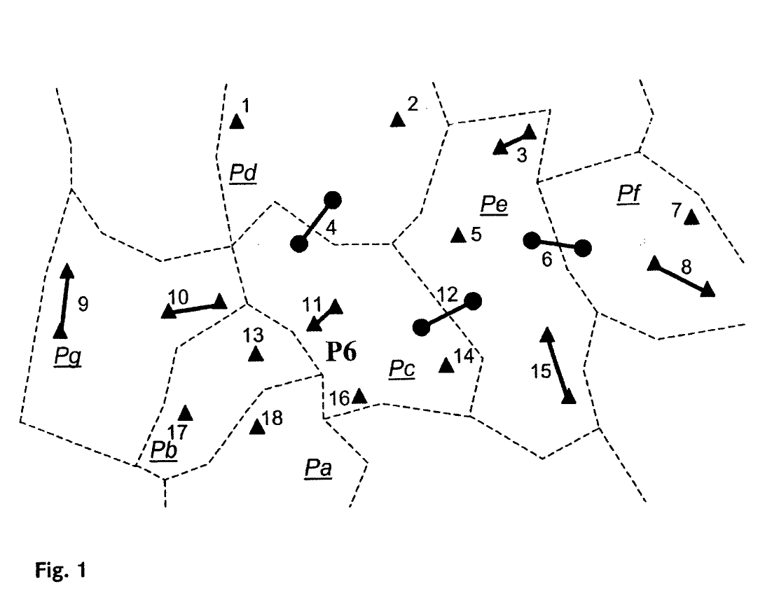

FIG. 1 is a schematic view of an exemplary use of versions and partitions of the second digital map at the control center end,

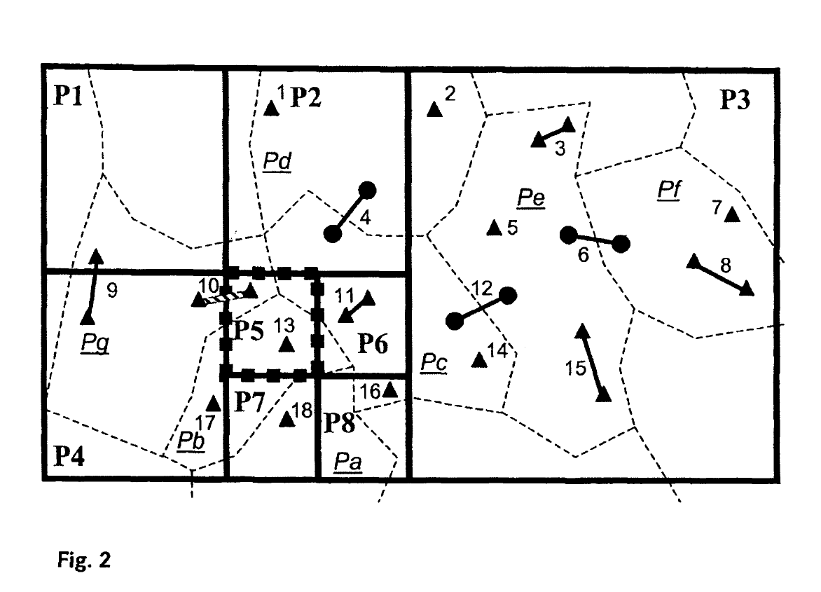

FIG. 2 is a schematic view of an exemplary use of partitions of the digital map in the user end device together with partitions of the second digital map at the control center end,

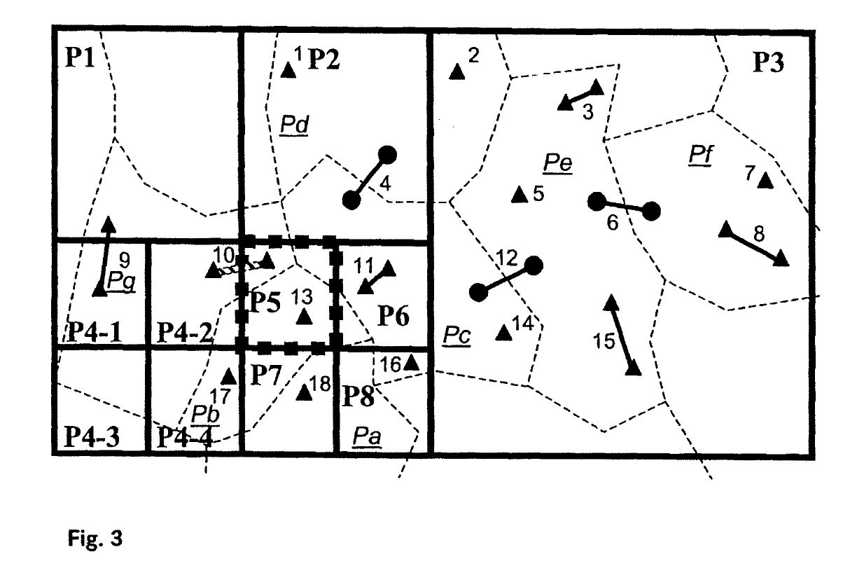

FIG. 3 is a schematic view of a further exemplary use of partitions of the digital map in the user end device together with partitions of the second digital map at the control center end,

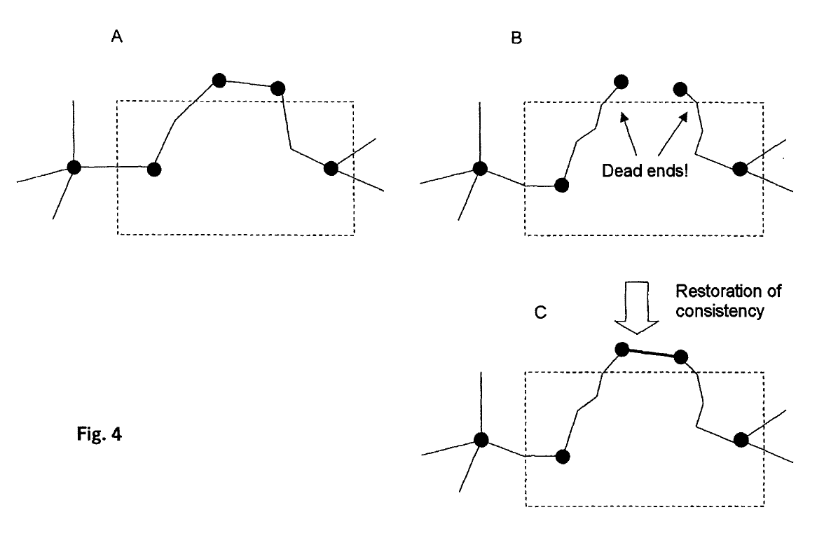

FIG. 4 is a schematic view of how consistency is ensured by avoiding dead ends,

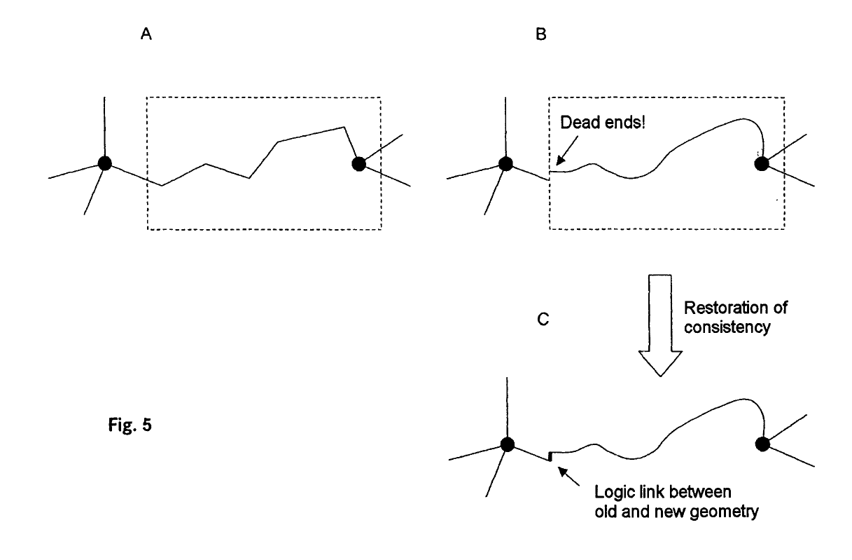

FIG. 5 is a schematic view of how consistency is ensured when element inaccuracies are corrected,

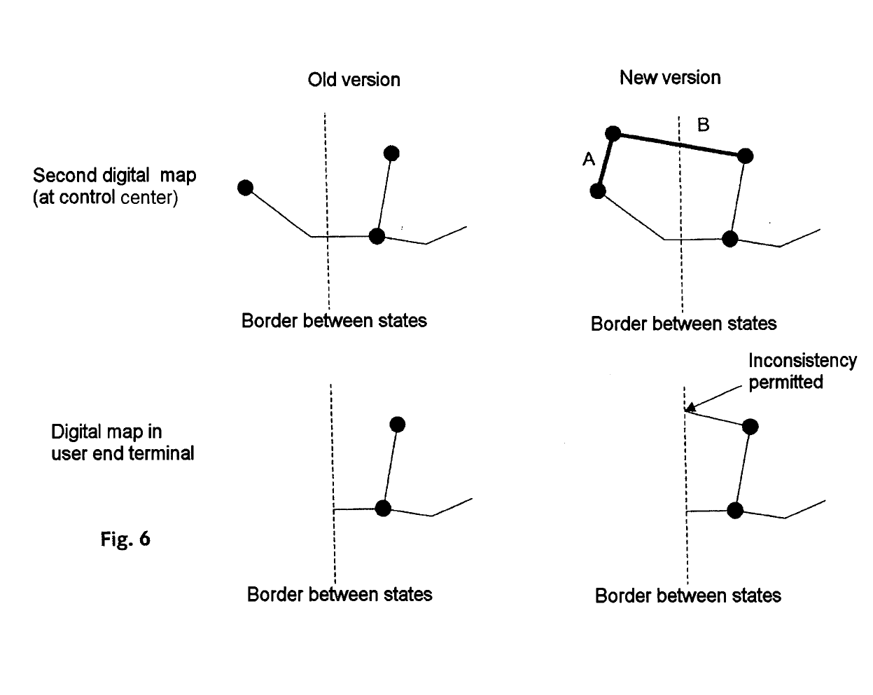

FIG. 6 shows a first, permitted degree of inconsistency by way of example,

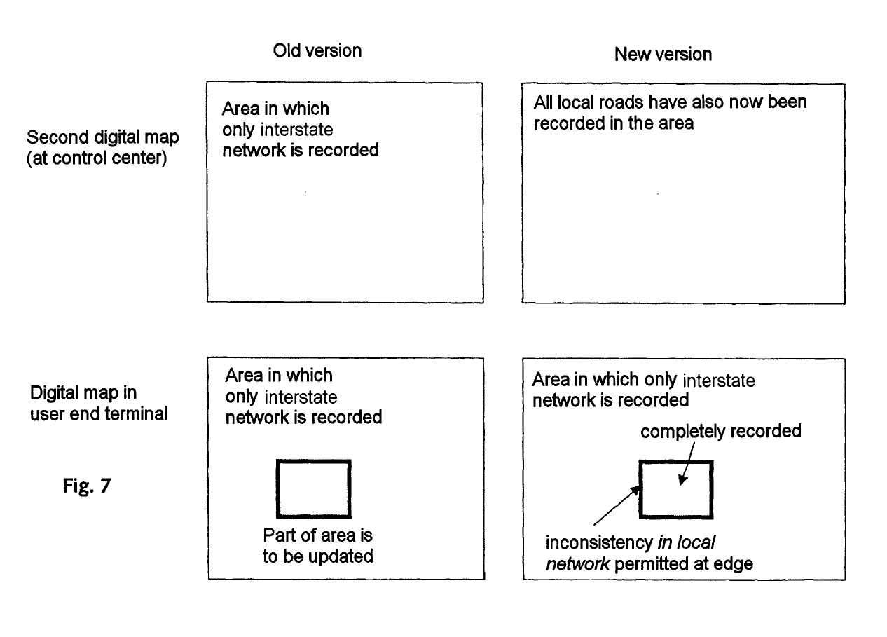

FIG. 7 shows a second, permitted degree of inconsistency by way of example,

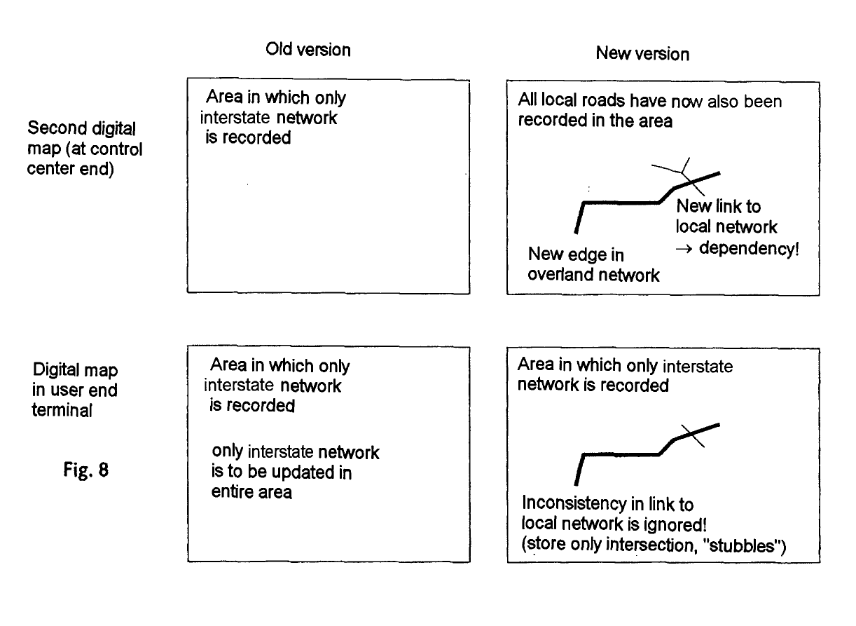

FIG. 8 shows a third permitted degree of inconsistency by way of example, and

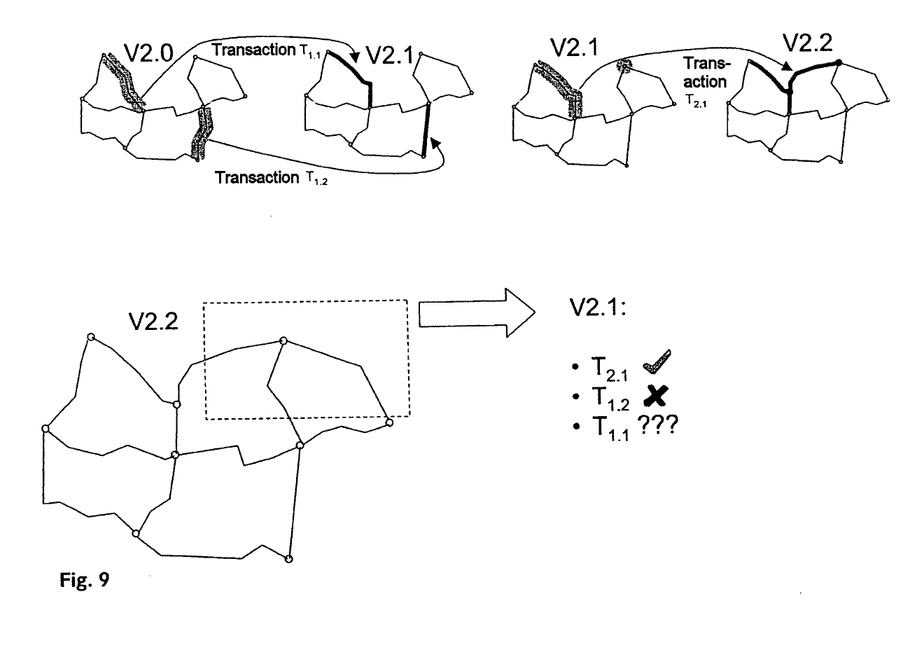

FIG. 9 shows dependencies of update transactions by way of example.

The exemplary use of partitions and versions of a digital map is presented schematically in FIG. 1. Partitions—that is to say specific geographic a real breakdown of the digital map—and versions—that is to say data versions of elements of the digital map at a specific time—are the basis of the update according to the invention. Modern digital maps are broken down into geographic areas in various ways. The map manufacturers usually supply their digital maps in broken down versions which are associated with administrative subdivisions (for example borders between states). The digital map in the user end terminal is frequently broken down in a way (for example as “panels” corresponding to the size of the memory) which permits even computer systems with restricted computing power and a limited processing means, such as that of a vehicle navigation device, to easily process the elements included in the digital map.

In order to carry out the updating process, the digital map is broken down into partitions as specific geographic areas. An update transaction is an update of a set of elements of precisely one partition of the digital map. Each partition has a version as a number of update transactions for this partition. A “later” version includes at least all the update transactions of “earlier” versions and, if appropriate, an update of further elements. In this context, entire partitions are always updated, an updating of only individual elements of a partition is nowadays not provided owing to the administrative complexity when managing individual elements of a digital map. In order to update a partition, all the update transactions which have a later version than the version of the digital map in the user end terminal up to the latest version which is present in the control center are supplied to the digital map using a second digital map at the control center end. In order to update any desired element subset of the digital map in the user end terminal, it is automatically checked which partitions have an overlap with the element subset to be updated. All these partitions are then updated.

FIG. 1 is a schematic view of an exemplary use of partitions Pa, Pb, Pc, Pd, Pe, Pf Pg of the second digital map at the control center end, with elements 1, 2, 3, 4, 5, 6, 7, 8, 9, 10, 11, 12, 13, 14, 15, 16, 17, 18 which are updated. The partitions correspond here to administrative subdivisions such as borders between states and borders between districts, and form element subsets of a digital map which are to be updated. The digital map is embodied here as a road map, with, for example, route planning for a vehicle navigation device being provided as a user application. In this context, new elements are supplied by a respective update of the road map in the vehicle navigation device, in a specific example the elements 17 and 3 when partition Pb is updated. Here, “supplied” can mean that these elements are newly added to the road map, or merely that existing elements are updated, with the elements being supplied to the vehicle navigation device using the second road map arranged in the control center, and with the second road map being continuously updated.

The elements 1, 2, 3, 4, 5, 6, 7, 8, 9, 10, 11, 12, 13, 14, 15, 16, 17, 18 which are updated relate either to elements which are specific points (triangles without a connecting line) such as, for example, POIs (“points of interest”, location positions of interest such as, for example, restaurants), or to route elements (triangles or circles with a connecting line). Updated route elements are located either completely within a partition (triangles with a connecting line) or are contained only partially in a partition and “protrude” into an adjacent partition (circles with a connecting line). Then, it is possible to ensure uniform numbering of the versions of a partition, even if this element change is broken down into a plurality of components, with each component describing the element change in precisely one partition. The consistency of the road map is not ensured, however, after the updating of individual partitions which do not all include components of an element change. Although an update of such a partition can make available a reference to other partitions which include a component of the element changes—enabling the user end device to correspondingly update further partitions in an automated fashion. This generally leads, however, to a large number of further partitions being updated, and in an extreme case to the entire road map being updated.

If, for example, partition Pc from FIG. 1 is updated, for an element 4 which is to be updated a reference to other updates in partition Pd would be made available, and for an element 12 which is to be updated a reference to other updates in partition Pe would be made available. During the updating of partition Pe which is then brought about, a reference to updates in partition Pf would in turn be made available. Instead of the updating of partition Pc—which is actually all that is desired—the partitions Pc, Pd, Pe and Pf would therefore be updated in order to maintain the consistence of the road map.

The road map in the user end device is usually broken down in a way which permits efficient access operations and processing of the elements in terms of computing. For this reason, a breakdown into “rectangular” partitions, for example as “panels” corresponding to the memory size, is usually employed, as part of the user application (PSF, “physical storage format”). FIG. 2 is a schematic representation of such an exemplary use of partitions of the road map in the user end device for the element subset from FIG. 1.

In all cases, the PSF-oriented partitioning of the road map in the user end device differs from the administratively oriented partitioning of the second road map in the control center. Here, it is more efficient to perform updates of the road map in the user end device for the PSF-oriented partitions and not for the administratively oriented partitions. As a result, subsets of the road map in the user end device which do not correspond to an administratively oriented partition need to be capable of being updated.

Therefore, if, for example, an update of a PSF-oriented partition is requested from the control center as a subset of the road map in the user end device, these can be covered partially or entirely by a plurality of the administratively oriented partitions of the second road map in the control center. FIG. 2 is a schematic view of an exemplary use of PSF-oriented partitions P1, P2, P3, P4, P5, P6, P7, P8 of the road map in the user end device together with administratively oriented partitions Pa, Pb, Pc, Pd, Pe, Pf, Pg of the second road map at the control center end for the element subsets from FIG. 1. The partition P5 which is outlined by dashed lines partially covers the partitions Pb, Pc and Pg. While each of these partitions Pb, Pc and Pg (at the control center end) in the second road map may have a different version, a uniform version number is made available to the road map by the partition P5 which is to be updated (in the user end device). This results here again in the problem presented already according to which the updating of an element can affect a plurality of partitions—see the dashed line in FIG. 2—and as a result inconsistencies can occur in the updated road map in the user end device. Here too, it is possible for the user end device to “reload” other partitions of the second road map in accordance with what has been stated above. However, in this case the PSF-oriented partitioning of the road map in the user end device is not known in the control center. The required PSF-oriented partitions thus have to be determined by the user end device in that the element change or each element change made available by the control center is checked to determine whether a component of the element change relates to an “adjacent” (i.e. further) partition. In the case presented in FIG. 2 this would result in such a determination (for example using the geo-coordinates of the elements shown by dashed lines) that in addition it would be necessary to request updating of the partition P4 from the control center. However, such an additional request is not necessary if an element change—also relating to an adjacent partition—does not lead to inconsistency in the road map in the user end device. An example of such an element change is the number of lanes on a route which “protrudes” into an adjacent partition changing from one to two lanes.

Similarly to the administratively oriented partitioning, there is also the problem here that when adjacent partitions are updated further dependencies may be found. Because of the element change 9 which extends over the boundary of partition P4 and partition P1, partition P1 would also have to be requested after the updating of P4. The smaller the partitions are in this context, the lower the probability of a further dependence. Given flexible PSF-oriented partitioning, which permits subsequent division of a partition into relatively small units, the size of an adjacent partition to be updated can be reduced. FIG. 3 shows a division of the partition P4 from FIG. 2 into the partitions P4-1, P4-2, P4-3 and P4-4. Since the element change 10 which is shown by dashed lines only relates to the partition P4-2, updating of this partition P4-2 restores the consistency of the road map. The element change 9 is thus not transmitted, as a result of which the transmitted data volume is significantly reduced, specifically on the one hand with the elimination of the element change 9 itself (not requested), and on the other hand, with the elimination of updates of the partition P1 which is “dependent” on the element change 9.

FIG. 4 is a schematic view of how the consistency is ensured by avoiding dead ends. A represents a subset of elements in the form of edges and nodes which have been newly added to the second digital map (at the control center). A user end device requests an update of an element subset of the digital map, corresponding to the dashed region. If exclusively elements of the second digital map which are included at least partially by the element subset to be updated were then supplied to the digital map of the user end device, the dead ends represented by B would result. For this reason, in order to restore the consistency of the digital map, an individual element, as represented under C, is selected automatically as part of an additional element subset and also supplied to the digital map of the user end device. This individual element ensures that there are no routes in the digital map updated in a subset at whose ends users would inevitably have to turn around if these routes are not also included in the second digital map.

FIG. 5 is a schematic view of the said ensuring of the consistency in the case of corrections of element inaccuracies. A represents a subset of elements in the form of edges and nodes whose inaccuracies have been corrected in the second digital map (at the control center end) by renewed measurement. A user end device requests an update of an element subset of the digital map, corresponding to the dashed region. If those elements of the second digital map which have a more up to date version than the version of the digital map—specifically those whose inaccuracies have been corrected and which are arranged under B within the dashed region, i.e. the region to be updated—are supplied to the digital map in the user end device, the dead end represented under B would be produced. For this reason, in order to restore the consistency of the digital map, an individual element, as displayed under C, is selected automatically as part of an additional element subset and also supplied to the digital map of the user end device. This individual element constitutes a logic link between elements of the updated subset of the digital map and those of the non-update subset of the digital map.

FIGS. 6, 7 and 8 each show different permitted inconsistencies by way of example. If the digital map in the user end device only has part of the second digital map arranged in the control center, the inconsistency of the digital map is permissible at locations at which a boundary runs between a part of a region which is included in the digital map in the user end device and a part of a region which is not included.

The is represented for an edge sequence A, B which has been newly added to the second digital map, is shown in bold in FIG. 6 and extends beyond a border between states. Here, inconsistency is permitted in the digital map in the user end device since the part of a region of the second digital map which lies outside the border between states is not included in the digital map in the user end device.

FIG. 7 displays an inconsistency which is permitted for a part of a region of road classes. In the older version of the digital map and the second digital map which is used by the user end device or at the control center end, only the interstate road network is recorded in the area shown. In the new version of the area, local roads are then also recorded. The updating of a part of an area shown in bold in FIG. 7 is then requested by the user end device as a subset of the second digital map. Here, an inconsistency is permitted at the edge of part of an area to be updated in the digital map in the user end device since the part of the region of road classes of the second digital map which lies outside the subset to be updated is not included in the digital map in the user end device.

A further permitted inconsistency is shown in FIG. 8. A part of a region of road classes is considered again. In the old version of the digital map and of the second digital map which is used by the user end device or at the control center end, respectively only the interstate road network is recorded in the area shown. In the new version of the area, local roads are then also recorded and additionally a new road has been added in the interstate road network. The updating of the interstate road network in the entire area as a subset of the second digital map is then requested by the user end device. Here, an inconsistency when there are connections to local roads is ignored in the digital map in the user end device since such connections are only stored in the digital map in the user end device in the form of stubbles.

FIG. 9 shows by way of example dependencies of update transactions. The second digital map in the control center, version V2.0, is firstly updated to a newer version V2.1 by update transactions T_{1,1} and T_{1,2}. The version V2.1 is then updated to the version V2.2 by an update transaction T_{2,1}. In this context, in each case the elements with grey backgrounds are changed to the elements with black backgrounds. In the lower part of FIG. 9, a dashed area is shown, corresponding to an element subset which is requested by a user end device and is to be updated. The digital map of the user end device has a version V2.1 in the dashed area. So that the digital map of the user end device has consistency after the updating of the element subset to be updated, the update transaction T_{2,1}, but not the update transaction T_{1,2}, has to be transmitted as an additional element subset for updating the digital map. The update transaction T_{1,1} is to be transmitted, in order to update the digital map, only if the version of the digital map of the user end device outside the element subset to be updated is older than version V2.1.

In addition, for the user end device, or for each user end device, the version of the partition, or of each partition, can be stored at the control center end, in which case in addition it is also possible to store updates which have been carried out on individual partitions. In the example in FIG. 9, the control center would thus be aware of whether the digital map of the requesting device had already been supplied at an earlier time with an update of the area outside the dashed region to version V2.1. As a result, it is possible to decide in the control center whether, for the new enquiry, it is also necessary to transmit the update transaction T_{1,1}in order to update the digital map. It is thus basically possible to avoid retransmitting to the terminal update transactions which have already been transmitted, thus reducing the data volume which has to be transmitted.

Two embodiments will be outlined briefly for the case in which, in a second step, the user end terminal checks whether additional element subsets of the digital map are affected by the update and an update of these additional element subsets is requested automatically by the control center as a function of the result of the check, in such a way that after the data of the additional element subsets has been received and supplied the digital map has consistency with respect to the user application, or to each user application running on the user end terminal. Here there is provision in each case for only element changes which are also part of the element subset to be updated to be included in the additional element subset but for there to be no inclusion of element changes on which a selected element change depends and which are located entirely outside the element subset to be updated—as a result of which it is not necessary to store any dependencies between element changes of the second digital road map in the control center—and it is subsequently checked in the user end terminal which adjacent regions of the digital road map are affected by the element changes and a further update is requested for these regions by the control center.

In a first embodiment, the checking in the user end terminal to determine whether additional element subsets of the digital map are affected by the update is not carried out until after the effects resulting from the data supplied for the updating of the element subset to be updated have been calculated, in which case an update of these additional element subsets is requested automatically by the control center as a function of the result of the check. This calculation is carried out in such a way that the parts of the update are “cut off” by elements which “protrude” beyond the element subset to be updated.

In a second embodiment, a calculation in the user end terminal of the effects resulting from the data supplied for the updating of the element subset to be updated is not started in advance. Instead, the additional element subsets of the digital map which are affected by the update are immediately requested automatically by the control center. The calculation of the effects resulting from the data supplied for the updating of the element subset to be updated is then started using all the supplied data.

1-15. (canceled)

16. A method for updating a digital map comprising elements of a traffic route network, in a user end device on which at least one user application of the digital map runs, relative to a second digital map arranged in a control center, comprising the steps of:
selecting an element subset of the digital map to be updated at the user end device;
requesting updating of the selected element subset from the control center via an at least temporary data link;
selecting an updated element subset from the second digital map from the control center;
determining whether an additional element subset at the user end device should be updated to maintain the digital map internally consistent after updating of the selected element subset;
selecting the additional element subset from the second digital map if it is determined in the determining step that updating is needed to maintain internal consistency of the digital map; and
transmitting at least one of the selected updated element subset and the updated additional element subset from the control center to the user end device.

17. A method for updating a digital map comprising elements of a traffic route network, in a user end device on which at least one user application of the digital map runs, relative to a second digital map arranged in a control center, comprising the steps of:
selecting an element subset of the digital map to be updated at the user end device;
requesting updating of the selected element subset from the control center via an at least temporary data link;
transmitting updated element subset data from the second digital map from the control center to the user end device via an at least temporary data link;
determining at the user end device after receipt of the updated element subset whether at least one additional element subset of the digital map require updating to maintain the digital map internally consistent;
requesting updating of the at least one additional element subsets; and
transmitting updated additional element subset data from the second digital map from the control center to the user end device.

18. The method as claimed in claim 16, wherein
the element subset to be updated comprises at least one of a geographic area, a route as a series of edges, a class of routes, one or more points of interest, and classes of points of interest

19. The method as claimed in claim 17, wherein
the element subset to be updated comprises at least one of a geographic area, a route as a series of edges, a class of routes, one or more points of interest, and classes of points of interest

20. The method as claimed in claim 18, wherein
consistency with respect to the user application which is running or with respect to any user application which is running on the user end device is ensured by selecting the additional element subset in such a way that after the data for updating the additional element subset has been supplied there is at least one of:
no route in the digital map of the user end device at whose end it is necessary for traffic route network users to turn around if this route is not also included in the second digital map,
no two routes at whose ends traffic route network users must turn around if the two routes are connected in the second digital map by a small number of edges,
no routes on which allocated turning around restrictions apply which are included in the second digital map as a result of at least one of routes and route data which is relevant to reaching a point of interest is as up to date as the data of the point of interest itself, and element dependencies are transmitted completely.

21. The method as claimed in claim 19, wherein
consistency with respect to the user application which is running or with respect to any user application which is running on the user end device is ensured by selecting the additional element subset in such a way that after the data for updating the additional element subset has been supplied there is at least one of:
no route in the digital map of the user end device at whose end it is necessary for traffic route network users to turn around if this route is not also included in the second digital map,
no two routes at whose ends traffic route network users must turn around if the two routes are connected in the second digital map by a small number of edges,
no routes on which allocated turning around restrictions apply which are included in the second digital map as a result of at least one of routes and route data which is relevant to reaching a point of interest is as up to date as the data of the point of interest itself, and
element dependencies are transmitted completely.

22. The method as claimed in claim 16, wherein
the at least temporary data link between a user end device and control center is a mobile radio link.

23. The method as claimed in claim 17, wherein
the at least temporary data link between a user end device and control center is a mobile radio link.

24. The method as claimed in claim 16, wherein
the user end device automatically requests control center updating at least one of periodically and when a user application of the digital map is started.

25. The method as claimed in claim 17, wherein
the user end device automatically requests control center updating at least one of periodically and when a user application of the digital map is started.

26. The method as claimed in claim 16, further comprising the steps of:
transmitting further data items from the control center to the user end device for use restoring a logic link between specific updated elements from the second digital map and inconsistent non-corrected elements in the digital map at the user end device; and
creating the logic link to eliminate internal inconsistencies at the user end device.

27. The method as claimed in claim 17, further comprising the steps of:
transmitting further data items from the control center to the user end device for use restoring a logic link between specific updated elements from the second digital map and inconsistent non-corrected elements in the digital map at the user end device; and
creating the logic link to eliminate internal inconsistencies at the user end device.

28. The method as claimed in claim 16, wherein
data for updating the element subset to be updated includes elements of the second digital map contained only partially in the element subset to the updated.

29. The method as claimed in claim 17, wherein
data for updating the element subset to be updated includes elements of the second digital map contained only partially in the element subset to the updated.

30. The method as claimed in claim 18, wherein
information about partitions constituting a decomposition of the digital map on a geographic basis in the user end device are stored at the control center end, and
a geographic area which is to be updated is identifiable by a corresponding partition reference.

31. The method as claimed in claim 19, wherein
information about partitions constituting a decomposition of the digital map on a geographic basis in the user end device are stored at the control center end, and
a geographic area which is to be updated is identifiable by a corresponding partition reference.

32. The method as claimed in claim 16, wherein
the user end device is registered at the control center end and identifies itself to the control center when there is a request to the control center.

33. The method as claimed in claim 17, wherein
the user end device is registered at the control center end and identifies itself to the control center when there is a request to the control center.

34. The method as claimed in claim 16, wherein
the user end device transmits version information for an element subset to be updated when there is a request to the control center.

35. The method as claimed in claim 17, wherein
the user end device transmits version information for an element subset to be updated when there is a request to the control center.

36. The method as claimed in claim 16, wherein
an upper limiting value is provided for the size of at least one additional element subset.

37. The method as claimed in claim 17, wherein
an upper limiting value is provided for the size of at least one additional element subset.

38. The method as claimed in claim 16, wherein
logically associated element updates are transmitted in combination.

39. The method as claimed in claim 17, wherein
logically associated element updates are transmitted in combination.

40. The method as claimed in claim 16, wherein
if the digital map in the user end device only has a part of the second digital map, inconsistency of the digital map is permitted at points at which there is a boundary between a part which is included in the second digital map and a part which is not included in the user end device.

41. The method as claimed in claim 17, wherein
if the digital map in the user end device only has a part of the second digital map, inconsistency of the digital map is permitted at points at which there is a boundary between a part which is included in the second digital map and a part which is not included in the user end device.

42. A system for carrying out the method as claimed in claim 16, comprising:
a user end device comprising memory for storage of the digital map and a transceiver for communicating with the control center via the at least temporary data link; and
a control center comprising control center memory for storing for the second digital map and a transceiver for communicating with the user end device via the at least temporary data link.

43. A system for carrying out the method as claimed in claim 17, comprising:
a user end device comprising memory for storage of the digital map and a transceiver for communicating with the control center via the at least temporary data link; and
a control center comprising control center memory for storing for the second digital map and a transceiver for communicating with the user end device via the at least temporary data link.
